(19) United States
(12) Patent Application Publication
(10) Pub. No.: US 2026/0119343 A1
(43) Pub. Date: Apr. 30, 2026

(54) HOT STANDBY SYSTEM AND METHOD, ELECTRONIC DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Sanxia CHEN, Suzhou, Jiangsu (CN); Tiejun LIU, Suzhou, Jiangsu (CN); Jun YANG, Suzhou, Jiangsu (CN); Peiqiang DONG, Suzhou, Jiangsu (CN); Dafeng HAN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/470,476

(22) PCT Filed: Oct. 12, 2024
(86) PCT No.: PCT/CN2024/124475

§ 371 Date: Oct. 31, 2025

(30) Foreign Application Priority Data
Feb. 29, 2024 (CN) 202410227354.3

(51) Int. Cl. G06F 11/1482; G06F 11/1446; G06F 11/20; G06F 11/30

(52) U.S. Cl. CPC G06F 11/1484; G06F 11/1464; G06F 11/2033; G06F 11/3055

(57) ABSTRACT

Provided are a Hot Backup system and method, and an electronic device and a storage medium. The system includes: an accelerator card, correspondingly connected to a primary server on a one-to-one basis, connected to a standby server in a sharing manner, and configured to acquire operating state information, operation log information, memory information, and configuration information of the primary server, in a case where determining, according to the operating state information, that the primary server has crashed, acquire data to be processed that is to be transmitted to the primary server, and transmit the operation log information, the memory information, the configuration information, and the data to be processed to the standby server; and the standby server, configured to generate, through simulation, a virtual application environment of the primary server and execute an application service of the primary server.

### CROSS-REFERENCE TO RELATED APPLICATION

This disclosure is a National Stage Filing of the PCT International Application No. PCT/CN2024/124475 filed on Oct. 12, 2024, which claims priority to Chinese Patent Application No. 202410227354.3 filed to the China National Intellectual Property Administration on Feb. 29, 2024 and entitled “Hot Backup System and Method, and Electronic Device and Storage Medium”, the disclosure of which is hereby incorporated by reference in its entirety.

### TECHNICAL FIELD

The present disclosure relates to a hot backup (HB) system and method, and an electronic device and a storage medium.

### BACKGROUND

In today's information age, server software applications have become the core of enterprise information systems, and in particular, the fault tolerance and continuity of critical service systems are of paramount importance. Failures or data loss in critical service system software on servers may lead to serious consequences such as service interruptions, data loss, influences on the reputation of enterprises, significant economic losses for the enterprises, etc. Therefore, how to perform HB in a convenient and efficient manner has become a key technology for ensuring data security and service continuity.

In the related art, in a multi-server system, it is generally necessary to correspondingly configure at least one standby server for each primary server on a one-to-one basis, such that each group of primary-standby servers, in a dual-machine HB manner, stores memory information of the primary server in a disk array or hard disk storage region through network sharing to perform HB of data. The inventors realized that such backup method not only requires the configuration of a large number of redundant standby servers, but also requires the storage and transmission of the memory information through network sharing, introducing high transmission latency and limited bandwidth, thus resulting in high hardware deployment and maintenance costs and low primary-standby switching efficiency.

### SUMMARY

According to embodiments of the present disclosure, a first aspect provides a hot backup method, including: acquiring, by an accelerator card acquires, operating state information, operation log information, and configuration information of a primary server from the primary server correspondingly connected to the accelerator card; storing, in a mirrored manner, memory information of the primary server in a memory of the primary server to a Compute Express Link (CXL) memory of the accelerator card through a CXL interface of the accelerator card, and determining whether the primary server has crashed according to the operating state information; in a case where the primary server has crashed, using the primary server which has crashed as a crashed primary server, acquiring data to be processed that is to be transmitted to the crashed primary server, and transmitting, to a standby server, the operation log information, the memory information, and the configuration information of the crashed primary server, and the data to be processed; and
generating, by the standby server through simulation, a virtual application environment of the crashed primary server according to the operation log information, the memory information, and the configuration information of the crashed primary server, and executing an application service of the crashed primary server according to the virtual application environment and the data to be processed.

According to the embodiments of the present disclosure, a second aspect further provides a hot backup system, including: a plurality of accelerator cards, a plurality of primary servers, and one standby server.

The accelerator cards are correspondingly connected to the primary servers on a one-to-one basis, and connected to the standby server.

Each accelerator card includes a CXL interface and a CXL memory.

The accelerator card is configured to acquire operating state information, operation log information, and configuration information of a primary server from the primary server correspondingly connected to the accelerator card; store, in a mirrored manner, memory information of the primary server in a memory of the primary server to the CXL memory through a CXL interface, and determine whether the primary server has crashed; in a case where the primary server has crashed, use the crashed primary server as a crashed primary server, acquire data to be processed that is to be transmitted to the crashed primary server, and transmit, to the standby server, the operation log information, the memory information, and the configuration information of the crashed primary server, and the data to be processed.

The standby server is configured to generate a virtual application environment of the crashed primary server through simulation according to the operation log information, the memory information, and the configuration information of the crashed primary server, and execute an application service of the crashed primary server according to the virtual application environment and the data to be processed.

According to the embodiments of the present disclosure, a third aspect further provides an electronic device, including a memory, a processor, and computer-readable instructions that are stored on the memory and executable on the processor. Wherein when the processor executes the program, the method of the above first aspect is implemented.

According to the embodiments of the present disclosure, a fourth aspect further provides a non-volatile computer readable storage medium, storing computer-readable instructions thereon. Wherein when the computer-readable instructions, are executed by a processor, the method of the above first aspect is implemented.

According to the embodiments of the present disclosure, a fifth aspect further provides a computer program product, including computer-readable instructions. Wherein when the computer-readable instructions, are executed by a processor, the method of the above first aspect is implemented.

The details of one or more embodiments of the present disclosure are set forth in the drawings and the description below. Other features and advantages of the present disclosure will be apparent from the drawings and the claims from the specification.

### BRIEF DESCRIPTION OF THE DRAWINGS

In order to more clearly illustrate the present disclosure or the technical solutions in the related art, the drawings used in the description of the embodiments or the related art will be briefly described below. It is apparent that the drawings in the following descriptions are some embodiments of the present disclosure. Other drawings can be obtained from those skilled in the art according to these drawings without any creative work.

FIG. 1 is a schematic structural view of a dual-machine HB system according to the related art.

FIG. 2 is a schematic structural diagram of an HB system according to an embodiment of the present disclosure.

FIG. 3 is a schematic structural diagram of an accelerator card according to an embodiment of the present disclosure.

FIG. 4 is a working flowchart of an accelerator card according to an embodiment of the present disclosure.

FIG. 5 is a schematic flowchart of data backup management according to an embodiment of the present disclosure.

FIG. 6 is a schematic flowchart of primary-standby switching according to an embodiment of the present disclosure.

FIG. 7 is a schematic flowchart of a primary-standby switching step according to an embodiment of the present disclosure.

FIG. 8 is a schematic flowchart of a hot backup method according to an embodiment of the present disclosure.

FIG. 9 is a schematic structural diagram of an electronic device according to an embodiment of the present disclosure.

FIG. 10 is a schematic diagram of a non-volatile computer readable storage medium according to an embodiment of the present disclosure.

### DETAILED DESCRIPTION OF THE EMBODIMENTS

In order to make objectives, technical solutions, and advantages of the present disclosure clearer, the technical solutions in the present disclosure will be clearly and completely described below in combination with the drawings in the present disclosure. It is apparent that the described embodiments are part of the embodiments of the present disclosure, not all the embodiments. All other embodiments obtained by those of ordinary skill in the art on the basis of the embodiments in the present disclosure without creative work all fall within the scope of protection of the present disclosure.

Terms “first”, “second” and the like in the present disclosure are used for distinguishing similar objects rather than describing a specific sequence or a precedence order. It is to be understood that data used in this way is exchangeable in a proper case, so that the embodiments of this application can be implemented in an order other than those shown or described herein, and that the objects distinguished by “first”, “second”, etc. are generally of one kind and do not limit the number of objects, e.g., the first object may be one or more than one. In addition, “and/or” represents at least one of the connected objects, and the character “/” generally indicates that the connected objects are in an “or” relationship.

In today's information age, server software applications have become the core of enterprise information systems, and in particular, the fault tolerance and continuity of critical service systems are of paramount importance. Failures or data loss in critical service system software on servers may lead to serious consequences such as service interruptions, data loss, influences on the reputation of enterprises, significant economic losses for the enterprises, etc. Therefore, for enterprises that need to ensure information security and provide uninterrupted information services, the fault tolerance and continuity of service systems are particularly important. How to ensure the continuous operation of various critical applications and achieve a virtuous cycle of sustainable operations, Disaster restoration (DR) and HB have become key technologies for ensuring data security and service continuity.

DR means that, in a server software application, a series of measures are taken to ensure that a system may restore to a normal operating state as quickly as possible after a disaster event occurs. The main principle of DR is to quickly restore server software by backing up critical data and system configuration information and establishing a backup hardware and software environment.

HB refers to maintaining data consistency between a primary server and a standby server in the server software application through real-time synchronization of data and configuration information. In a case where the primary server fails or data is lost, the standby server may immediately take over the work of the primary server to ensure service continuity. The main principle of HB is to achieve data synchronization and switching between the primary and standby servers through real-time data replication and dual-machine HB technologies.

The HB technology is widely used in industries with high requirements for data security and continuity, such as finance, telecommunications, healthcare, and data centers, and is currently one of the mainstream fault-tolerant technologies for application servers, especially a dual-machine HB technology. Therefore, in the related art, the data security and service continuity are realized based on dual-machine HB.

Dual-machine HB in the related art have two implementation modes. One is based on shared storage devices, and the other does not use shared storage devices and is generally referred to as a pure software mode.

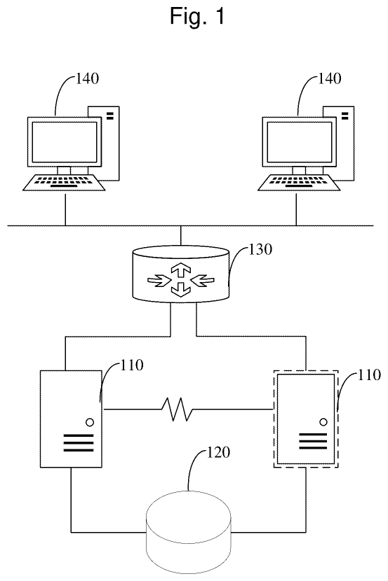

FIG. 1 is a schematic structural view of a dual-machine HB system according to the related art. As shown in FIG. 1, the dual-machine HB based on storage sharing is the most standard solution for dual-machine HB. In this method, two servers 110 communicate with clients 140 through a switch 130 to realize service processing; and the two servers 110 perform data synchronization and switching processing by using a shared storage device 120, such as a disk array cabinet or a Storage Area Network (SAN). The two servers 110 may operate in different ways, such as mutual backup, master-slave, or parallel. During operation, the two servers 110 provide services externally using a virtual Internet Protocol (IP) address, and based on different operation modes, a service request is sent to one of the servers to bear. Furthermore, the server detects the operation status of another server through a heartbeat line, for example, by means of establishing a private network. In a case where one server fails, another server makes a judgment based on heartbeat detection and switches over to take over the service. For a user, this process is fully automated and completed in a very short time, without affecting the service. Since the shared storage device is used, the two servers actually use the same data, which is managed by dual-machine or cluster software.

For a pure software mode, the data may be replicated to another server through dual-machine software that supports mirroring, such that the same data is stored on both servers. If one server fails, the other server may be immediately switched in a timely manner.

Therefore, in a multi-server system, it is generally necessary to correspondingly arrange at least one standby server for each primary server on a one-to-one basis, and an HB server causes the primary and standby servers to be always in a power-on state, so as to maintain configuration synchronization, such that each group of primary-standby servers, in a dual-machine HB manner, stores memory information of the primary server in a disk array or hard disk storage region through network sharing, so as to perform HB of data to realize rapid restoration of DR data and avoid data loss. However, device investment is high, communication costs are high, communication environment requirements are high, software maintenance and upgrades, system hardware upgrades, and daily operation and management are relatively complex. Furthermore, memory information needs to be stored and transmitted through network sharing, introducing high transmission latency and limited bandwidth.

To sum up, the dual-machine HB solution in the related art has the disadvantages of high hardware deployment and maintenance costs and low primary-standby switching efficiency.

In view of the above disadvantages, the present disclosure provides an HB system and method, and an electronic device and a storage medium, which are suitable for a system in which a plurality of devices implement hot back at the same time, especially suitable for the implementation of an HB function in a case where the plurality of devices operate single functions at the same time. In the present disclosure, while the number of standby servers during dual-machine HB may be reduced, a fault-tolerant rate is not reduced, such that hardware deployment and maintenance costs are reduced, and a primary-standby switching speed is accelerated.

The HB system and method, and the electronic device and the storage medium provided in the embodiments of the present disclosure are described in detail below through specific embodiments and application scenarios thereof, with reference to the drawings.

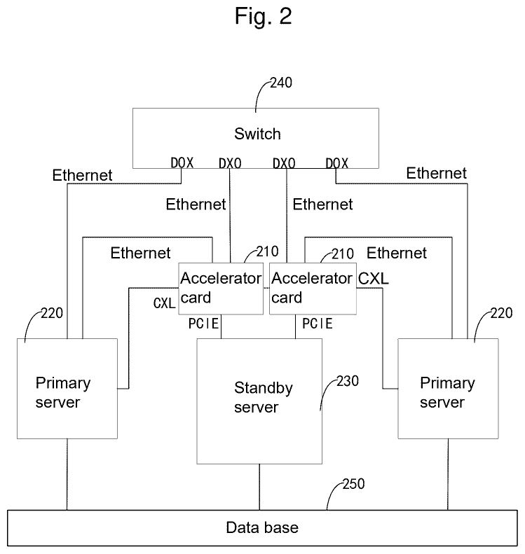

FIG. 2 is a schematic structural diagram of an HB system according to the present disclosure. As shown in FIG. 2, the system includes a plurality of accelerator cards 210, a plurality of primary servers 220, and one standby server 230. Each accelerator card 210 is correspondingly connected to each primary server 220 on a one-to-one basis, and connected to the standby server 230.

The number of the accelerator cards here may be adaptively set according to the number of the primary servers, for example, being the same as the number of the primary servers, or a preset multiple of the number of the primary servers. The accelerator card may be a Peripheral Component Interconnect Express (PCIE) accelerator (hereinafter referred to as a PCIE intelligent Ethernet card).

Each accelerator card may be correspondingly connected to each primary server on a one-to-one basis to achieve backup sharing between each accelerator card and the primary server. Each accelerator card may be a small system device plugged into the standby server, such that a power supply and main body for the accelerator card are installed on the standby server. Therefore, in a case where the primary server fails or is powered off, the accelerator card on the standby server is not affected. The accelerator card may achieve its intelligent media function of shared storage, triggering the standby server to start and take over a service of a host. Such system management mode may maximize the function of the standby server.

The standby server may switch between different accelerator cards to quickly respond to and repair different fault primary servers through backup sharing information between different accelerator cards and the primary servers, and switch back to the corresponding primary server for operation in a case where the fault primary server is restored to normal, such that the primary and standby servers may have same or different configurations, as long as the standby server covers all the configurations of the primary server, so as to adapt to a system environment same as the primary server. For example, the standby server here may be configured as a system environment with higher specifications than all the primary servers, so as to provide HB standby services for the plurality of primary servers at the same time.

It is to be noted that, since the probability of the plurality of primary servers failing simultaneously is almost the same as the probability of the primary and standby servers failing simultaneously, the one-to-many HB system provided in this embodiment does not reduce the fault-tolerant rate of the dual-machine HB solution. In particular, in a case where the standby server uses a server having higher specifications to support a single machine fault-tolerant technology, the one-to-N HB system provided in this embodiment, which is an HB system including one standby server and N primary servers, may realizes the reliability of 1+1+1/N, the fault-tolerant rate is greater than that of traditional dual-machine HB, and costs are reduced compared to the plurality of standby servers. Therefore, the HB system provided in this embodiment has larger technical improvement compared to the related art, and may not only reduce the costs, but also improve the effect of the fault-tolerant rate.

In some embodiments, each accelerator card includes a first Ethernet interface, a CXL interface, and a CXL memory.

The first Ethernet interface is connected to a network port of the primary server, and is configured to acquire operating state information, operation log information, and configuration information of the primary server from a management module of the primary server.

The CXL interface is connected to a memory interface of the primary server, and is configured to acquire, in a mirrored manner, memory information of the primary server from a memory of the primary server.

The CXL memory is configured to store the memory information that are transmitted by each server in a mirrored manner, and transmit the memory information to each server.

In some embodiments, each accelerator card further includes a PCIE interface.

The PCIE interface is connected to the standby server, and is configured to transmit, to the standby server, the operation log information, the memory information, and the configuration information of a crashed primary server, as well as data to be processed.

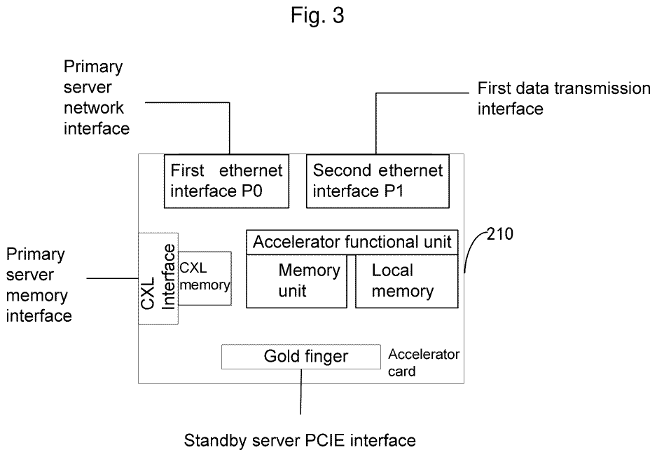

FIG. 3 is a schematic structural diagram of an accelerator card according to the present disclosure. As shown in FIG. 3, the accelerator card 210 includes a plurality of interfaces, which include at least a first Ethernet interface P0, a CXL interface, and a PCIE interface.

The first Ethernet interface P0 here may be a dual-interface high-speed Ethernet interface; the CXL interface may be a PCIE X16 high-speed cable expansion interface that supports a CXL 2.0 protocol; the PCIE interface may be a gold finger interface of a PCIE edge interface (PCIE EDGE) that supports PCIE 5.0 X16.

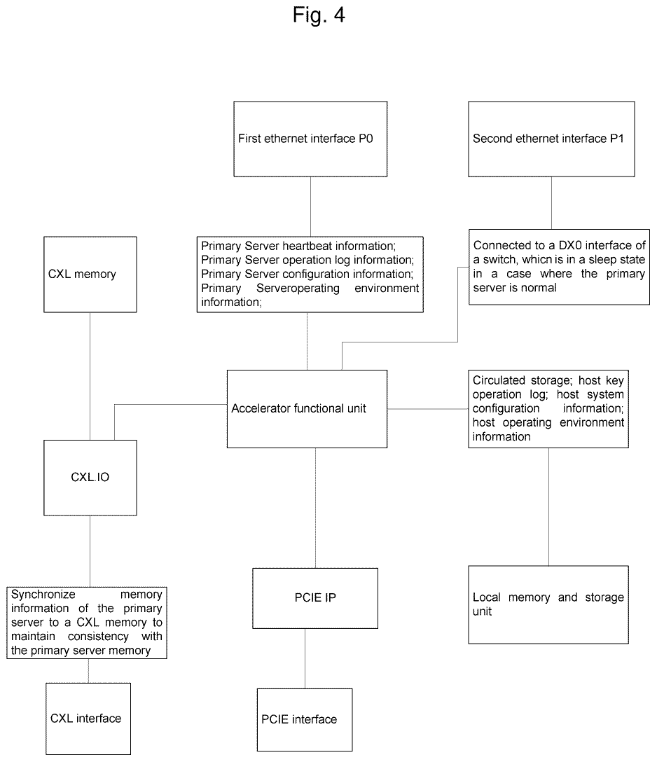

FIG. 4 is a working flowchart of an accelerator card according to the present disclosure. As shown in FIG. 4, the first Ethernet interface P0 is connected to the network port of the primary server, such as a management network port or a normal network, and performs private network communication through software, so as to monitor and acquire the operating state information, operation log information, and configuration information of the primary server. The operating state information includes at least heartbeat information; and the configuration information includes at least system configuration information and operating environment configuration information.

CXL is an open industry interconnect standard, may provide a high-bandwidth and low-latency connection between the primary server and devices such as the accelerator card, a memory buffer, a smart Input/Output (I/O) device etc., thereby meeting the requirements of high-performance heterogeneous computing, and maintains consistency between a memory space of a Central Processing Unit (CPU) memory space and a memory of a connected device memory.

The CXL interface may be connected, through an external cable, to a memory interface of the primary server with the same CXL expansion interface within 3 meters. In a case where the primary server is in a normal operating state, the accelerator card locally have two slots of Double Data Rate (DDR) memories as shadow memories of the primary server connected to the CXL interface, maintaining data synchronization with the memory of the primary server at all times.

The PCIE interface is connected to and communicates with the standby server. In a case where the primary server has crashed, the accelerator card quickly communicates with the standby server through the PCIE interface to start the transmission of the operation log information, the memory information, and the configuration information of the crashed primary server stored on a local end to the standby server, and the standby server quickly restores the state of the crashed primary server to achieve service switching. The PCIE interface used here communicates with the standby server through a PCIE bus protocol. The main memory information big data is transmitted to the memory of the standby server in the form of big data files. Compared with a CXL bus protocol, the PCIE protocol has better latency and bandwidth than a CXL bus when transferring big data memory, especially for large-capacity unidirectional data reading.

The CXL memory may be a DDR4 memory expansion slot that supports double channels, with a maximum capacity of 512 GB. Since the CXL memory has read-write bandwidth and latency that are second only to a local server memory, and has read-write efficiency that is significantly higher than that of a hard drive and Ethernet, such that by using the CXL memory as a real-time shared storage space, a data synchronization rate of the primary and standby servers is much faster than that of a traditional dual-machine HB technology. A data loss rate is significantly smaller during the switching of the primary and standby servers, thereby achieving faster primary-standby switching efficiency.

Compared to a shared storage (i.e., a server system operating memory for HB) space in related art storing operation information in a shared disk array or hard disk storage region via a network, in this embodiment, the memory information of the primary server is mirrored in real time to the shared CXL memory through the CXL protocol. Compared with network hard disk storage, CXL storage is an enhanced version of PCIE, having a faster data transmission speed and lower latency, such that the speed of switching nodes of the primary and standby servers may be greatly accelerated. Therefore, in this embodiment, the use of the CXL memory as the shared storage space for dual-machine HB may effectively accelerate the speed of switching the nodes of the primary and standby servers, thereby improving service continuity. Each accelerator card is configured to acquire, through the first Ethernet interface, the operating state information, the operation log information, and the configuration information of the primary server from the management module of the primary server correspondingly connected to each accelerator card; store, in a mirrored manner, memory information of the primary server in the memory of the primary server to the CXL memory through the CXL interface, and determine whether the primary server has crashed according to the operating state information; in a case where the primary server has crashed, use the primary server which has crashed as the crashed primary server, acquire data to be processed that is to be transmitted to the crashed primary server, and transmit, to a standby server, the operation log information, the memory information, and the configuration information of the crashed primary server, and the data to be processed.

The standby server is configured to generate a virtual application environment of the crashed primary server through simulation according to the operation log information, the memory information, and the configuration information of the crashed primary server, and execute an application service of the crashed primary server according to the virtual application environment and the data to be processed.

Optionally, during HB, each accelerator card may monitor the management module of the primary server in real time through the first Ethernet interface, so as to acquire the operating state information, the operation log information, and the configuration information of the primary server; acquire the memory information of the primary server in real time in a mirrored manner from the memory of the primary server through the CXL interface; store the memory information of the primary server to the CXL memory in real time; determine, whether the primary server has crashed according to the operating state information; so as to identify the primary server which has crashed as the crashed primary server in a case where the primary server has crashed, and timely receive the data to be processed of the crashed primary server; and transmit, to the standby server in real time, the operation log information, configuration information, and data to be processed of the crashed primary server, as well as the memory information of the crashed primary server stored in the CXL memory.

In a case where the standby server learns that the primary server has crashed, the standby server enters an active mode from a sleep mode, and configures the virtual application environment of the crashed primary server according to the operation log information, the memory information, and the configuration information of the crashed primary server in a case where the operation log information, the memory information, the configuration information, and the data to be processed of the crashed primary server are acquired, causing the configured virtual application environment to match the application environment of the crashed primary server, thereby better taking over the application service of the crashed primary server. After it is determined that the virtual application environment of the crashed primary server is generated, the data to be processed may be processed in the virtual application environment matching the application environment of the crashed primary server, such that the application service of the crashed primary server is taken over.

The HB system provided in this embodiment may realize HB of the plurality of servers sharing one standby server by adding an accelerator card of a small system on the same standby server, and the primary and standby servers do not need to remain synchronized at all times, and only need to rapidly transmit, to the standby server in real time in a case where a failure in the primary server is monitored, the operation log information and the configuration information of the crashed primary server that are shared and backed up by the accelerator card, as well as the memory information of the primary server that is stored by the primary server in real time in a mirrored manner using the CXL memory and data to be processed that is about to be transmitted to the crashed primary server, such that the standby server may rapidly restore a data service of the crashed primary server according to the operation log information, the memory information, and the configuration information of the crashed primary server, as well as the data to be processed. Therefore, the HB system has significant advantages of being small in data loss, fast in restoration, and small in device investment, may accelerate the rapid primary-standby switching speed and improve a restoration function and service continuity while device deployment costs are reduced, thereby ensuring the data fault-tolerant rate and online service quality of the servers.

In some embodiments, each accelerator card further includes a second Ethernet interface.

The second Ethernet interface is connected to a first data transmission interface of a switch 240, and is configured to acquire the data to be processed from the switch 240.

As shown in FIG. 3, the accelerator card further includes the second Ethernet interface P1, and the second Ethernet interface P1 may also be a dual-interface high-speed Ethernet interface.

As shown in FIG. 4, the second Ethernet interface P1 is configured to be connected to the first data transmission interface of the switch competing with the primary server. A specific competitive relationship is configured by the switch. In a case where the primary server operates normally, the second Ethernet interface P1 enters the sleep mode, and the switch prioritizes the sending of the data to be processed (e.g., user data to be processed) to the primary server. In a case where the primary server has crashed, such as disconnected or unresponsive, the second Ethernet interface P1 enters the active mode from the sleep mode, and the switch automatically switches to transmit the data to be processed to the standby server through the second Ethernet interface P1. The second Ethernet interface P1 also maintains the switching from the active mode to the sleep mode at all times according to a monitored operating state of the primary server, or switches from the sleep mode to the active mode.

In some embodiments, each accelerator card further includes a local memory and a storage unit.

The local memory is configured to store the operating state information, the operation log information, and the configuration information transmitted by each server within a first time period.

The storage unit is configured to circularly store the operating state information, the operation log information, and the configuration information transmitted by each server within a second time period.

A time interval between each time point within the first time period and a current time is less than or equal to a preset interval, and a time interval between each time point within the second time period and the current time is greater than or equal to the preset interval.

As shown in FIG. 3, the accelerator card is also configured with the local memory and the storage unit. The local memory may be a memory that supports a local memory cache space up to 288G; and the storage unit may be an expandable Secure Digital (SD) card storage space.

The accelerator card receives the operating state information, the operation log information, and the configuration information, store the newly-acquired operating state information, operation log information, and configuration information in a case where determining, according to the operating state information, that the primary server is normal, and circularly store the historically-acquired operating state information, operation log information, and configuration information to the storage unit from the local memory.

The accelerator card in the system provided in this embodiment supports multi-memory data storage including the CXL memory, the local memory, and the storage unit. Through rational storage and time interval control, the data transmission efficiency may be improved, information of the server is rapidly stored and accessed, and historical data is reserved for subsequent analysis and processing, thereby accelerating the speed of switching the nodes of the primary and standby servers, and improving service continuity.

In some embodiments, each accelerator card further includes an Accelerator Functional Unit (AFU).

The AFU is a local data scheduling system of the accelerator card, is implemented by a Field-Programmable Gate Array (FPGA), and thanks to the characteristics of an internal structure of the FPGA and its high-speed parallel capabilities, may easily implement the switching of a distributed algorithm structure and a high-speed interface, making it particularly suitable for high-speed digital signal processing and parallel data development.

The AFU is configured to perform data scheduling and management of the entire system, simultaneously supports the CXL memory, and also locally supports a large capacity local memory and a local SD card storage space, and may be configured to perform local data caching and data storage. The AFU is crucial to the HB system, and may implement the one-to-many HB solution.

In some embodiments, the AFU may be provided with a 128G memory space, which may be configured to cache server data received by the interface P0 and the interface P1, as well as user data to be processed (hereinafter referred to as data to be processed), and provide a network card service of network switching for the standby server in a case where the standby server starts the service.

The AFU is specifically configured to perform the following operations.

Heartbeat information of the primary server is parsed and acquired from the operating state information.

In a case where determining, according to the heartbeat information, that a heartbeat of the primary server is abnormal, determining that the primary server has crashed, and sending device start request information to the standby server through the PCIE interface according to a fault identifier of the crashed primary server.

In a case where start response information returned by the standby server is received, transmitting the operation log information and configuration information of the crashed primary server to the standby server.

The start response information is returned by the standby server in a case where a system resource of the standby server meets a device resource configuration requirement of the crashed primary server, and the device resource configuration requirement is associated and acquired according to the fault identifier.

It is to be noted that, since the AFU uses the FPGA as a master control chip, partial step flow executed by the AFU may be performed in parallel, and in a case where triggering is performed without special circumstances, such as primary server failure, the step flows do not affect each other. In the following, the partial step flow that is executed by the AFU in parallel may be configured according to actual requirements, and are not specifically limited herein.

Data backup steps between the accelerator card, the primary server correspondingly connected to the accelerator card, and the standby server are described below.

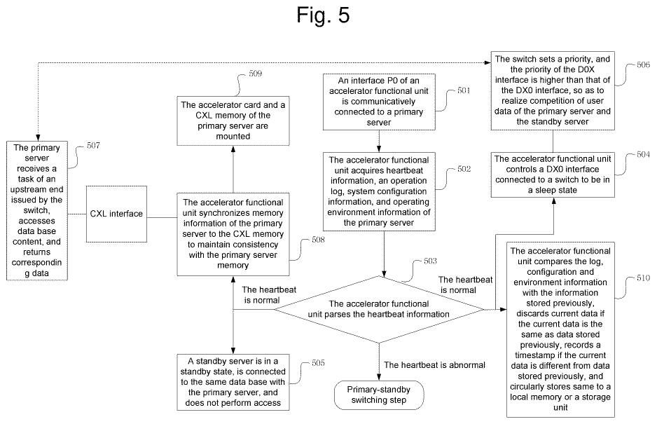

FIG. 5 is a schematic flowchart of data backup management according to the present disclosure. As shown in FIG. 5, after each accelerator card is inserted in the standby server, the step of data backup management includes the following steps.

At S501, the first Ethernet interface P0 of the AFU is communicatively connected to a network port of the primary server.

At S502, the AFU acquires the operating state information, the operation log information, and the configuration information of the primary server through the first Ethernet interface P0.

At S503, after acquiring the operating state information, the AFU may parses and acquire the heartbeat information of the primary server from the operating state information, and determine, according to the heartbeat information, whether the heartbeat of the primary server is abnormal; if the heartbeat of the primary server is normal, determine that the primary server is normal, and then execute the data backup management step; and if the heartbeat of the primary server is abnormal, determine that the primary server has crashed, and then execute a primary-standby switching step.

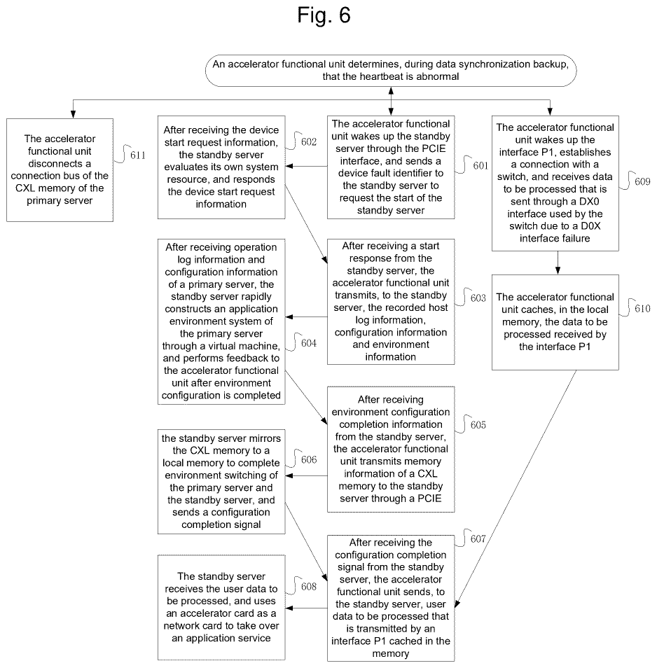

FIG. 6 is a schematic flowchart of primary-standby switching according to the present disclosure. As shown in FIG. 6, in a case where it is determined that the primary server has crashed, the primary server crashed is used as the crashed primary server, and the following steps are executed to implement the primary-standby switching step.

At S601, the AFU wakes up the standby server through the PCIE interface, generates, according to the fault identifier of the crashed primary server, the device start request information for fault restoration, and sends a device start request information to the standby server through the PCIE interface.

At S602, after receiving the device start request information, the standby server evaluates its own system resources, and responds to the device start request information for fault restoration. The step specifically includes the following operations: the standby server parses and acquires the fault identifier from the device start request information to associate and acquire a device resource configuration requirement of the crashed primary server through the fault identifier, evaluates its own system resources through the device resource configuration requirement, that is, determines whether its own system resources meet the device resource configuration requirement of the crashed primary server, returns abnormal prompt information to the AFU in a case where its own system resources do not meet the device resource configuration requirement of the crashed primary server, so as to indicate that its own system resources do not meet the device resource configuration requirement of the crashed primary server, and returns start response information to the AFU in a case where its own system resources meet the device resource configuration requirement of the crashed primary server.

At S603, after receiving the start response information returned by the standby server, the AFU transmits, to the standby server, the operation log information and the configuration information acquired from the crashed primary server through sharing, such that the standby server rapidly performs subsequent primary-standby switching and takes over the application service of the crashed primary server.

For the system provided in this embodiment, a heartbeat signal is abnormal in a case where the primary server has crashed, the accelerator card timely triggers an interaction and switching process with the standby server, and transmits, to the standby server, the operation log information and the configuration information acquired from the crashed primary server through sharing, such that the standby server rapidly performs subsequent primary-standby switching and takes over the application service of the crashed primary server. Therefore, data continuity is achieved to a maximum extent, important data is protected from losing, and a rapid and secure primary-standby switching service is realized.

In some embodiments, the standby server is specifically configured to perform the following operations.

In a case where receives the operation log information and the configuration information of the crashed primary server, through a virtual machine, generating an initial application environment of the crashed primary server through simulation according to the operation log information and the configuration information of the crashed primary serve.

In a case where it is determined that the initial application environment has been generated through simulation, sending a first configuration completion message to the AFU through a PCIE interface.

Receiving the memory information of the crashed primary server that is transmitted by the AFU, and updating the initial application environment according to the memory information of the crashed primary server, to obtain the virtual application environment.

The memory information of the crashed primary server is transmitted by the AFU through the CXL memory in a case where receiving the first configuration completion message.

As shown in FIG. 6, the primary-standby switching step further includes the following steps.

At S604, after receiving the operation log information and the configuration information, the standby server may rapidly construct the initial application environment of the crashed primary server through simulation according to the operation log information and the configuration information through the virtual machine, and feed same back to the AFU in a case where the initial application environment is generated through simulation, where the specific feedback mode may be to send the first configuration completion message to the AFU through the PCIE interface; and the first configuration completion message is configured to indicate that the initial application environment of the crashed primary server is configured.

At S605, after receiving the first configuration completion message, the AFU may determine that the initial application environment of the crashed primary server is generated, and in this case, may transmit, to the standby server through the PCIE interface in a mirrored manner, the memory information of the crashed primary server that is stored in the CXL memory through sharing.

At S606, the standby server mirrors the memory information of the crashed primary server that is stored in the CXL memory to its local memory, and updates the initial application environment by relying on the memory information to obtain the virtual application environment, so as to realize primary-standby environment switching, such that subsequent primary-standby switching is performed rapidly, and the application service of the crashed primary server is taken over with a lower fault-tolerant rate.

In the system provided in this embodiment, in a case where the primary server has crashed, during data switching and standby server environment configuration, the standby server performs initial application environment simulation based on the operation log information and the configuration information of the crashed primary server, and locally stores the memory information of the crashed primary server that is stored in the CXL memory after initial application environment simulation is completed, thereby effectively realizing real-time environment backup, such that in a case where the primary server fails, the virtual application environment may be started rapidly to ensure the continuity and availability of the system.

In some embodiments, the standby server is further configured to perform the following operations.

In a case where it is determined that the virtual application environment has been generated, sending a second configuration completion message to the AFU through the PCIE interface.

Receiving the data to be processed that is sent by the AFU, wherein the data to be processed is data that sent by the AFU in a case where receiving the second configuration completion message.

Executing the application service of the crashed primary server according to the virtual application environment and the data to be processed.

As shown in FIG. 6, S606 further includes: after determining the virtual application environment is generated, feeding, by the standby server, the configuration completion message back to the AFU. The step may specifically include sending the second configuration completion message to the AFU through the PCIE interface; and the second configuration completion message here is configured to indicate that the virtual application environment is generated.

The primary-standby switching step further includes the following steps.

At S607, after receiving the second configuration completion message, the AFU sends, to the standby server, the user data to be processed that is cached in the memory and transmitted by the second Ethernet interface P1.

At S608, after receiving the user data to be processed, the standby server uses the accelerator card as a network card, and executes the application service of the crashed primary server based on the virtual application environment and the data to be processed, so as to take over the application service of the crashed primary server.

In some embodiments, the AFU is further configured to perform the following operations.

Waking up, the second Ethernet interface in a case where it is determined that the primary server has crashed.

Sending, a data transmission request to the switch through the second Ethernet interface according to the fault identifier of the crashed primary server.

Receiving, through the second Ethernet interface, the data to be processed that is transmitted by the switch, wherein the data to be processed is data that is transmitted by the switch in a case where receives the data transmission request.

As shown in FIG. 6, the primary-standby switching step further includes the following steps.

At S609, in a case where determining that the primary server has crashed, since the primary server has crashed, a second data transmission interface D0X of the switch enters a sleep state, in this case, the AFU wakes up the second Ethernet interface P1, and establishes a connection with a first data transmission interface DX0 of the switch, so as to receive the data to be processed that is transmitted by starting, by the switch, the first data transmission interface DX0 as the second data transmission interface D0X enters the sleep state.

At S610, the AFU caches, in the local memory, the data to be processed of the crashed primary server that is received by the second Ethernet interface P1.

In the system provided in this embodiment, during data switching and standby server environment configuration, the accelerator card synchronously caches the received user data. In a case where the standby server is ready for taking over the application service of the crashed primary server, the cached data to be processed of the crashed primary server is delivered to the standby server. Therefore, data continuity is achieved to a maximum extent, important data is protected from losing, and a rapid and secure primary-standby switching service is realized.

In some embodiments, the AFU is further configured to perform the following operations.

In a case where it is determined that the primary server has crashed, disconnecting a connection between the CXL interface and a memory interface of the crashed primary server.

As shown in FIG. 6, the primary-standby switching step further includes the following step.

At S611. In a case where determining that the primary server has crashed, the AFU disconnects a connection between a memory interface of the primary server crashed and the CXL interface for fault isolation, so as to prevent data confusion and inconsistency, thereby improving backup performance.

It is to be noted that, the above S601-606, S609-610, and S611 may be performed in parallel to improve backup efficiency.

In some embodiments, the AFU is further configured to perform the following operation.

In a case where it is determined, according to the heartbeat information, that the heartbeat of the primary server is normal, determining that the primary server is normal, controlling the first data transmission interface is controlled to enter a sleep mode through the second Ethernet interface, and controlling the standby server to be in a standby mode.

As shown in FIG. 5, the data synchronization backup step includes the following steps.

At S504, the AFU controls the first data transmission interface DX0 to enter the sleep mode through the second Ethernet interface P1.

At S505, the standby server is in the standby mode; and the standby server and the primary server are connected to, but do not access to, the same data base.

In the system provided in this embodiment, the standby server may be inserted with the plurality of accelerator cards and serves as the standby server for the plurality of primary servers. Moreover, in a case where all the primary servers are in a normal state, the standby server is in the sleep state, and only the accelerator card is in an operating state in real time, such that the reduction of system power consumption may be better facilitated, and the deployment of the standby servers is reduced. Furthermore, even if the accelerator card fails, the standby server may also serve as a monitoring host of the accelerator card, rapidly replaces the accelerator card through human-computer interaction, and thus plays a role in achieving optimization and security assurance of primary-standby shared storage spaces, thereby further improving the security of the entire HB system.

In some embodiments, the primary server is configured to perform the following operations.

In a case where it is determined, according to the heartbeat information, that the heartbeat of the primary server is normal and the first data transmission interface enters the sleep mode, establishing a connection with the second data transmission interface of the switch, to control the second data transmission interface to enter the active mode.

In a case where it is determined that the second data transmission interface enters the active mode, receiving the data to be processed through the second data transmission interface, and executing the application service according to the data to be processed.

As shown in FIG. 5, the data synchronization backup step further includes the following steps.

At S506, in a case where determining, according to the heartbeat information, that the heartbeat of the primary server is normal and the first data transmission interface DX0 enters the sleep mode, the switch sets a priority of the second data transmission interface D0X to be higher than that of the first data transmission interface DX0, so as to realize competition between the user data to be processed of the primary and standby servers.

At S507, in a case where determining that the second data transmission interface P1 enters the active mode, the primary server receives the data to be processed of the primary server through the second data transmission interface P1, accesses a data base to execute the application service according to the data to be processed of the primary server, and returns corresponding data.

In some embodiments, the data synchronization backup step further includes the following steps.

At S508, in a case where the heartbeat is normal, the primary server synchronously mirrors the memory information of the primary server to the CXL memory of the accelerator card, causing the CXL memory of the accelerator card to be consistent with the memory information stored by the memory of the primary server.

At S509, in a case where the CXL memory of the accelerator card completes the storage of the memory information, it is determined that the loading of the accelerator card and the memory of the primary server is completed.

In some embodiments, the data synchronization backup step further includes the following step.

At S510, in a case where the heartbeat is normal, the AFU also synchronously compares the current data, which is the operating state information, operation log information, and the configuration information, of the primary server with the previous storage record, discards data in the current data that is the same as the previous storage record, reserves different data, and records acquisition timestamps of different data, to circularly store the data in the local memory or storage unit according to the acquisition timestamps.

In the system provided in this embodiment, in a case where all the primary servers are in the normal state, the standby server is actually in the sleep state, and only the accelerator card and the primary server are in the operating state in real time. Only the primary server executes the application service, and the accelerator card performs shared storage on the information of the primary server, such that the reduction of system power consumption may be better facilitated, and the deployment of the standby servers is reduced.

In some embodiments, the AFU is further configured to perform the following operations.

In a case where receives a restoration request of the crashed primary server, determining that a crash event of the crashed primary server has been resolved, switching the crashed primary server to a primary server to be restored, and sending a switching request to the standby server.

Receiving switching response information, operation log information, and configuration information of the standby server.

In a case where it is determined, according to the switching response information, that the standby server allows switching, sending a first switching instruction and the operation log information and configuration information of the standby server to the primary server to be restored.

Receiving configuration state information of the primary server to be restored is received, wherein the configuration state information is generated by performing, by the primary server to be restored, application environment configuration according to the operation log information and configuration information of the standby server in a case where the primary server to be restored receiving the first switching instruction.

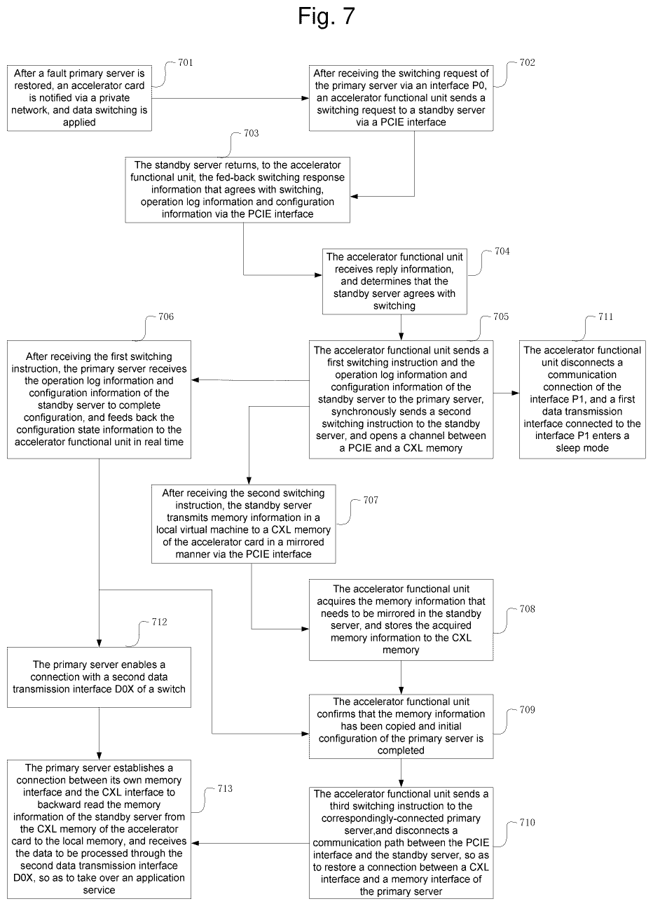

FIG. 7 is a schematic flowchart of a primary-standby switching step according to the present disclosure. As shown in FIG. 7, the primary-standby switching step includes the following steps.

At S701, after returning to normal from a failure, the primary server crashed notifies, via a private network, the AFU to request data switching, that is, the restoration request is sent to the AFU through the first Ethernet interface P0.

At S702, after receiving the restoration request of the primary server through the first Ethernet interface P0, the AFU determines that the crash event of the crashed primary server has been resolved, and may currently send a switching request to the standby server through the PCIE interface.

At S703, after receiving the switching request, the standby server sends the switching response information indicating agreement to switch to the AFU through the PCIE interface, and returns the operation log information and the configuration information of the standby server back to the AFU.

At S704, after receiving the switching response information, the AFU determines that the standby server allows with switching.

At S705, in a case where determining that the standby server allows with switching, the AFU sends, through the first Ethernet interface P0, a first switching instruction and the operation log information and the configuration information of the standby server to the primary server to be restored (e.g., the primary server to be restored).

At S706, after receiving the first switching instruction, the primary server to be restored performs application environment configuration according to the operation log information and the configuration information of the standby server, and feeds the configuration state information back to the AFU in real time, such that subsequent acceleration units read the memory information of the standby server back to the primary server to be restored, and then the primary server to be restored continues to execute the application service, thereby realizing standby-primary switching.

In the system provided in this embodiment, after returning to normal, the primary server notifies the accelerator card that it returns to normal, and requests to switch back to the primary server; after receiving the request, the accelerator card sends a switching request to the standby server; the standby server sets a breakpoint according to the operating state, and returns the switching response information that switching is allowed, the operation log information, and the configuration information back to the accelerator card; and after analyzing that switching is allowed, the accelerator card returns the first switching instruction that switching is allowed, the operation log information, and the configuration information back to the primary server, such that the primary server performs system configuration. Therefore, switching is performed at the appropriate time, rapid system restoration is realized, and system downtime is reduced, thereby improving the availability and stability of the backup system.

In some embodiments, the AFU is further configured to perform the following operations.

In a case where it is determined, according to the switching response information, that the standby server allows switching, sending a second switching instruction to the standby server.

Acquiring memory information in the virtual application environment that is transmitted by the standby server through the PCIE interface in a mirrored manner.

Storing the memory information in the virtual application environment to the CXL memory.

The memory information in the virtual application environment is information that is transmitted by the standby server in a case where receives the second switching instruction.

As shown in FIG. 7, S705 further includes: in a case where determining that the standby server allows to switch, the AFU sends a second switching instruction to the standby server, and opens a channel between the PCIE interface and the CXL memory.

### The Standby-primary Switching Step Further Includes the Following Steps.

At S707, after receiving the second switching instruction, the standby server transmits, in a mirrored manner, the memory information in the virtual application environment constructed by a local virtual machine to the CXL memory of the accelerator card through the PCIE interface.

At S708, the AFU acquires the memory information that needs to be mirrored in the standby server, and stores same to the CXL memory.

It is to be noted that, S707-708 and S706 may be performed synchronously, that is, while the standby server returns the first switching instruction that switching is allowed, the operation log information, and the configuration information back to the primary server to be restored, and the primary server to be restored performs system configuration, the standby server synchronously writes the memory information to the CXL memory of the accelerator card through the PCIE interface; and in a case where receiving initial configuration completion of the primary server to be restored, the accelerator card may timely reads the memory information of the standby server in a mirrored manner from the CXL memory of the accelerator card, thereby avoiding information transmission latency, and improving data backup efficiency.

In some embodiments, the AFU is further configured to perform the following operation.

In a case where it is determined, according to the configuration state information, that the primary server to be restored has completed configuration and it is determined, according to storage state information of the CXL memory, that the memory information in the virtual application environment that is transmitted by the standby server has been stored, a third switching instruction is sent to the primary server to be restored, and disconnecting a communication path between the PCIE interface and the standby server, restoring a connection between the CXL interface and a memory interface of the primary server to be restored.

As shown in FIG. 7, the standby-primary switching step further includes the following steps.

At S709, the AFU determines, according to the configuration state information, whether the primary server to be restored is configured, and determines, according to the storage state information, whether the memory information in the virtual application environment that is transmitted by the standby server is stored, and performs S710 in a case where both configuration and storage are completed.

At S710, the AFU sends the third switching instruction to the primary server to be restored through the first Ethernet interface P0, so as to notify the primary server to be restored that switching may be performed; and at the same time, the communication path between the PCIE interface and the standby server is disconnected to restore the connection between the CXL interface and the memory interface of the primary server to be restored.

It is to be noted that, system information (e.g., the operating state information, operation log information, and configuration information) of the primary server and the standby server is implemented via the private network, and since the switching of the primary and standby servers need to synchronize the memory data and the system information, compared with a data size of the memory data, a data size of the system information is very small, and thus the delay may be ignored.

Furthermore, after the communication path between the standby server and the PCIE interface of the accelerator card is disconnected, and the standby server is released, the standby server may continuously monitor the expanded accelerator card, and the switching of the primary and standby states is performed again in a case where a failure is found in any primary server through the accelerator card. During backup, there may be a situation that the plurality of primary servers simultaneously require the standby server to provide the switching of application service states. In this case, the standby server is required to be a device of which performance and configuration are superior to that of the primary server, and may simultaneously start a plurality of virtual machines to take over services of more than two primary servers with in a short time, thereby greatly improving the reliability of the multi-server backup system. The probability of two primary servers failing simultaneously is the same as that of the primary and standby servers failing simultaneously, while the probability of the plurality of primary servers failing is even lower. Therefore, the security of the HB system provided in the present disclosure is higher than that of traditional dual-machine HB systems.

In the system provided in this embodiment, in a case where the accelerator card receives configuration completion of the primary server, the CXL memory closes the channel between the PCIE and the CXL memory after mirroring the information, and then opens a memory channel between an external CXL interface and the memory interface of the primary server to be restored, such that the primary server to be restored backward reads the memory information of the standby server and mirrors same to the local, so as to complete the switching of the standby server and the host, thereby ensuring that the memory data of the standby server remains synchronized with the primary server, and avoiding data loss or inconsistency. After the primary server acquires the latest memory information of the standby server, the application service is restored rapidly, and system downtime is reduced, thereby improving the availability of the HB system.

In some embodiments, the AFU is further configured to perform the following operation.

In a case where it is determined, according to the switching response information, that the standby server allows switching, disconnecting the connection with the first data transmission interface of the switch, to control the first data transmission interface to enter the sleep mode.

As shown in FIG. 7, the standby-primary switching step further includes the following step.

At S711, in a case where determining, according to the switching response information, that the standby server allows to switch, the AFU may synchronously disconnect a connection between the second Ethernet interface P1 and the first data transmission interface of the switch, causing the first data transmission interface to enter the sleep mode, such that the switch preferably transmits, through the second data transmission interface of the switch, the data to be processed to the corresponding primary server to be restored, causing the primary server to be restored to rapidly restore the application service.

It is to be noted that, S711 may be synchronously performed with S707-708 and S706 to improve the HB efficiency.

In some embodiments, the primary server to be restored is configured to perform the following operations.

In a case where it is determined that the first data transmission interface enters the sleep mode, enabling the connection with the second data transmission interface of the switch, to control the second data transmission interface to enter the active mode.

In a case where the third switching instruction is received and the second data transmission interface enters the active mode, receiving, through the second data transmission interface the data to be processed of the primary server to be restored.

Reading the memory information of the virtual application environment from the CXL memory through the CXL interface.

Updating an initial environment according to the memory information of the virtual application environment.

Restoring an application service of the primary server to be restored according to an updated application environment and the data to be processed of the primary server to be restored.

The initial environment is an environment that is generated by performing application environment configuration according to the operation log information and the configuration information of the standby server.

### As Shown in Fig. 7, the Standby-primary Switching Step Further Includes the Following Steps.

At S712, in a case where determining that the first data transmission interface enters the sleep mode, the primary server to be restored starts the connection with the second data transmission interface D0X of the switch, to control the second data transmission interface to enter the active mode.

At S713, in a case where the primary server to be restored receives the third switching instruction and the second data transmission interface enters the active mode, the primary server to be restored establishes a connection between its own memory interface and the CXL interface to backward read the memory information of the standby server to the local memory from the CXL memory of the accelerator card, and receives the data to be processed through the second data transmission interface D0X, such that the initial environment generated by configuring the application environment based on the operation log information and configuration information of the standby server is updated based on the acquired memory information, so as to restore the application service based on the updated application environment and the data to be processed.

The system provided in this embodiment achieves one-to-many HB through the PCIE accelerator card that may expand the CXL memory. During standby-primary switching, a host computer may know the operating state of the system only by paying close attention to the operating state of the same standby server at any time. Once the standby server is started, the standby server may rapidly respond to repair the primary server, then switch back to the primary server for operation, while the standby server remains on standby. The system is particularly suitable for an online service system, may realize rapid deployment, and thus has market innovation and leading advantages.

As shown in FIG. 2, the HB system further includes a data base 250.

The data base 250 is connected to each of the primary servers and the standby server in a shared manner.

Optionally, the data base is configured to perform shared storage on security data transmitted by the primary server and the standby server, and may specifically be managed by dual-machine or cluster software to safely store partial memory, thereby improving the availability, performance, and management efficiency of the system.

The HB method provided in the present disclosure is described below, and the HB method described below and the HB system described above may be correspondingly referenced to each other.

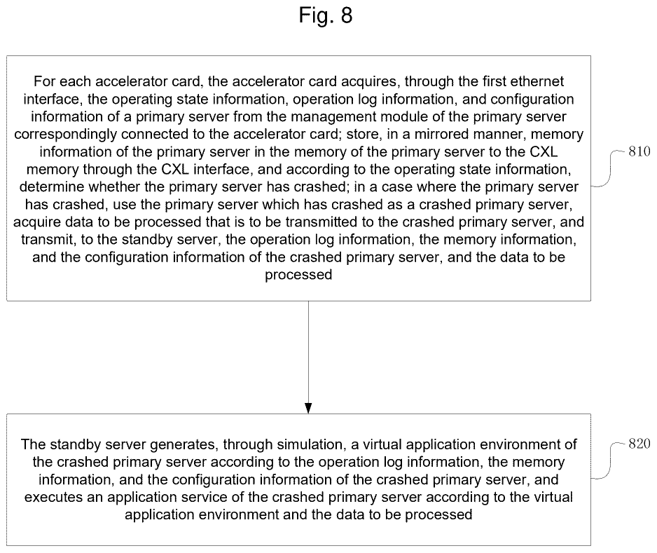

FIG. 8 is a schematic flowchart of an HB method according to the present disclosure. An execution subject of the method is the HB system provided in the above embodiments. As shown in FIG. 8, the method includes the following steps.

At S810, for each accelerator card, the accelerator card acquires, through the first Ethernet interface, the operating state information, operation log information, and configuration information of a primary server from the management module of the primary server correspondingly connected to the accelerator card; store, in a mirrored manner, memory information of the primary server in the memory of the primary server to the CXL memory through the CXL interface, and according to the operating state information, determine whether the primary server has crashed; in a case where the primary server has crashed, use the primary server which has crashed as the crashed primary server, acquire data to be processed that is to be transmitted to the crashed primary server, and transmit, to the standby server, the operation log information, the memory information, and the configuration information of the crashed primary server, and the data to be processed.

At S820, the standby server generates, through simulation, a virtual application environment of the crashed primary server according to the operation log information, the memory information, and the configuration information of the crashed primary server, and executes an application service of the crashed primary server according to the virtual application environment and the data to be processed.

Optionally, during HB, each accelerator card may monitors and acquires the operating state information, the operation log information, the memory information, and the configuration information of the primary server in real time, determine, based on the acquired operating state information, whether the primary server has crashed, to timely receive the data to be processed that is transmitted to the primary server in a case where the primary server has crashed, and transmit, to the standby server, the operation log information, the memory information, the configuration information, and the data to be processed of the primary server in real time.

In a case where the standby server learns that the primary server has crashed, the standby server enters the active mode from the sleep mode, and configures the virtual application environment of the primary server according to the operation log information, the memory information, and the configuration information of the primary server in a case where the operation log information, the memory information, the configuration information, and the data to be processed of the primary server are acquired, causing the configured virtual application environment to match the application environment of the primary server, thereby better taking over the application service of the primary server. After it is determined that the virtual application environment of the primary server is configured, the data to be processed may be processed in the virtual application environment matching the application environment of the primary server, such that the application service of the primary server is taken over.

In the HB method provided in this embodiment, the operation log information and the configuration information of the crashed primary server that are shared and backed up by the accelerator card, as well as the memory information of the primary server that is stored by the primary server in real time in a mirrored manner using the CXL memory and data to be processed that is about to be transmitted to the crashed primary server are rapidly transmitted to the standby server in a case where a failure in the primary server is monitored, such that the standby server may rapidly restore a data service of the crashed primary server according to the operation log information, the memory information, and the configuration information of the crashed primary server, and the data to be processed. Therefore, the HB system has significant advantages of being small in data loss, fast in restoration, and small in device investment, may accelerate the rapid primary-standby switching speed and improve a restoration function and service continuity while device deployment costs are reduced, thereby ensuring the data fault-tolerant rate and online service quality of the servers.

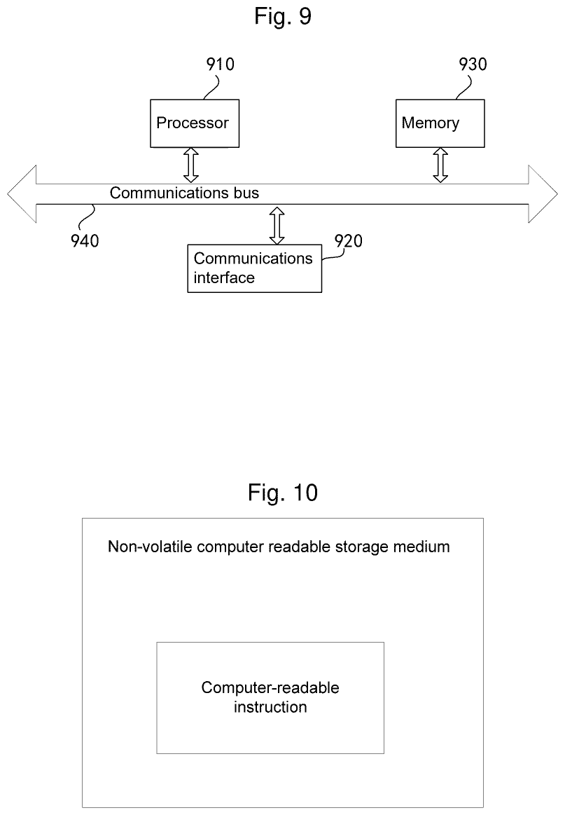

FIG. 9 is a schematic diagram of an entity structure of an electronic device. As shown in FIG. 9, the electronic device may include a processor 910, a communications interface 920, a memory 930, and a communication bus 940. The processor 910, the communications interface 920, and the memory 930 communicate with each other by using the communication bus 940. The processor 910 may call logical instructions in the memory 930 to perform an HB method.

In addition, the logical instructions in the memory 930 may be implemented in the form of the software functional unit and sold or used as an independent product, and may be stored in a computer-readable storage medium. Based on this understanding, the technical solutions of the present disclosure essentially or the parts that contribute to the related art, part of the technical solutions may be embodied in the form of a software product. The computer software product is stored in a storage medium, including a plurality of instructions for causing a computer device (which may be a personal computer, a server, or a network device, and the like) to execute all or part of the steps of the method in one or more embodiments of the present disclosure. The foregoing storage medium includes a USB flash disk, a mobile hard disk drive, a Read-Only Memory (ROM), a Random Access Memory (RAM), and media that can store program codes, such as a magnetic disk, or an optical disk.

In another aspect, the present disclosure further provides a computer program product. The computer program product includes computer-readable instructions. The computer-readable instructions may be stored on an on-transient computer readable storage medium. When the computer-readable instructions are executed by a processor, a computer can perform the HB method provided in the above one or more embodiments.

In another aspect, referring to FIG. 10, the present disclosure further provides a non-transient computer readable storage medium, storing computer-readable instructions thereon. The computer-readable instructions, in a case where executed by a processor, implement the HB method provided in the above one or more embodiments.

The apparatus embodiments described above are merely illustrative. The units described as separate components may or may not be physically separated. The components displayed as units may or may not be physical units, that is, the components may be located in one place, or may be distributed on the plurality of network units. Part or all of the modules may be selected according to actual requirements to achieve the purposes of the solutions of this embodiment. It can be understood and implemented by those of ordinary skill in the art without creative labor.

Through the description of the above implementations, those skilled in the art may clearly understand that the implementations may be implemented by means of software and a necessary general hardware platform, definitely, it may also be implemented by means of hardware. Based on this understanding, the above technical solution may be embodied in the form of a software product in essence, or the part that contributes to the related art. The computer software product may be stored in a computer-readable storage medium, such as ROM/RAM, a magnetic disk, an optical disk, and the like, and includes a plurality of instructions to cause a computer device (which may be a personal computer, a server, or a network device, or the like) to perform the method described in one or more embodiments or some parts of one or more embodiments.

It is to be noted at last: the above various embodiments are only used to illustrate the technical solutions of this application and not used to limit the same. Although this application has been described in detail with reference to the foregoing embodiments, for those of ordinary skill in the art, they may still modify the technical solutions described in the foregoing one or more embodiments, or equivalently replace part of the technical features; all these modifications and replacements shall not cause the essence of the corresponding technical solutions to depart from the spirit and the scope of the technical solutions of the embodiments of this application.

1. A hot backup method, comprising:
acquiring, by an accelerator card, operating state information, operation log information, and configuration information of a primary server from the primary server correspondingly connected to the accelerator card; storing, in a mirrored manner, memory information of the primary server in a memory of the primary server to a Compute Express Link (CXL) memory of the accelerator card through a CXL interface of the accelerator card, and determining whether the primary server has crashed according to the operating state information; in a case where the primary server has crashed, using the primary server which has crashed as a crashed primary server, acquiring data to be processed that is to be transmitted to the crashed primary server, and transmitting, to a standby server, the operation log information, the memory information, and the configuration information of the crashed primary server, and the data to be processed; and
generating, by the standby server through simulation, a virtual application environment of the crashed primary server according to the operation log information, the memory information, and the configuration information of the crashed primary server, and executing an application service of the crashed primary server according to the virtual application environment and the data to be processed.

2. The method according to claim 1, wherein the transmitting, to a standby server, the operation log information, the memory information, and the configuration information of the crashed primary server, and the data to be processed, comprises:
transmitting, to the standby server, the operation log information, the memory information, the configuration information of the crashed primary server, and the data to be processed, through a Peripheral Component Interconnect Express (PCIE) interface of the accelerator card, wherein the PCIE interface is connected to the standby server.

3. The method according to claim 2, the transmitting, to the standby server, the operation log information, the memory information, the configuration information of the crashed primary server, and the data to be processed, through a Peripheral Component Interconnect Express (PCIE) interface of the accelerator card, comprises:
parsing and acquiring, by the accelerator card, heartbeat information of the primary server from the operating state information;
in a case where it is determined, according to the heartbeat information, that a heartbeat of the primary server is abnormal, determining that the primary server has crashed, and sending device start request information to the standby server through the PCIE interface according to a fault identifier of the crashed primary server; and
in a case where start response information returned by the standby server is received, transmitting the operation log information and configuration information of the crashed primary server to the standby server;
wherein the start response information is information that is returned by the standby server in a case where a system resource of the standby server meets a device resource configuration requirement of the crashed primary server, and the device resource configuration requirement is a requirement that is associated and acquired according to the fault identifier.

4. The method according to claim 3, wherein the generating, by the standby server through simulation, the virtual application environment of the crashed primary server according to the operation log information, the memory information, and the configuration information of the crashed primary server comprises:
in a case where the standby server receives the operation log information and the configuration information of the crashed primary server, generating, by the standby server through simulation, an initial application environment of the crashed primary server according to the operation log information and the configuration information of the crashed primary serve;
in a case where it is determined that the initial application environment has been generated through simulation, sending a first configuration completion message to the accelerator card; and
receiving the memory information of the crashed primary server that is transmitted by the accelerator card, and updating the initial application environment according to the memory information of the crashed primary server to obtain the virtual application environment;
wherein the memory information of the crashed primary server is information that is transmitted by the accelerator card through the CXL memory in a case where the accelerator card receives the first configuration completion message.

5. The method according to claim 4, before the executing an application service of the crashed primary server according to the virtual application environment and the data to be processed, further comprising:
in a case where it is determined that the virtual application environment has been generated, sending, by the standby server, a second configuration completion message to an Accelerator Functional Unit (AFU) of the accelerator card;
receiving the data to be processed that is sent by the accelerator card, wherein the data to be processed is data that is sent by the accelerator card in a case where receiving the second configuration completion message.

6. The method according to claim 3, further comprising:
in a case where it is determined that the primary server has crashed, disconnecting, by the accelerator card, a connection between the CXL interface and a memory interface of the crashed primary server.

7. The method according to claim 3, wherein the acquiring the data to be processed that is to be transmitted to the crashed primary server comprises:
acquiring the data to be processed from a switch through a second Ethernet interface of the accelerator card, wherein the second Ethernet interface is connected to a first data transmission interface of the switch.

8. The method according to claim 7, further comprising:
waking up, by the accelerator card, the second Ethernet interface in a case where it is determined that the primary server has crashed;
sending a data transmission request to the switch through the second Ethernet interface according to the fault identifier of the crashed primary server; and
receiving, through the second Ethernet interface, the data to be processed that is transmitted by the switch, wherein the data to be processed is data that is transmitted by the switch in a case where the switch receives the data transmission request.

9. The method according to claim 7, further comprising:
in a case where it is determined, according to the heartbeat information, that the heartbeat of the primary server is normal, determining, by the accelerator card, that the primary server is normal, controlling the first data transmission interface to enter a sleep mode through the second Ethernet interface, and controlling the standby server to be in a standby mode.

10. The method according to claim 9, further comprising:
in a case where it is determined, according to the heartbeat information, that the heartbeat of the primary server is normal and the first data transmission interface enters the sleep mode, establishing, by the primary server, a connection with a second data transmission interface of the switch, to control the second data transmission interface to enter an active mode; and
in a case where it is determined that the second data transmission interface enters the active mode, receiving the data to be processed of the primary server through the second data transmission interface, and executing an application service of the primary server according to the data to be processed of the primary server.

11. The method according to claim 3, further comprising:
in a case where the accelerator card receives a restoration request of the crashed primary server, determining, by the accelerator card, that a crash event of the crashed primary server has been resolved, switching the crashed primary server to a primary server to be restored, and sending a switching request to the standby server;
receiving switching response information, operation log information, and configuration information of the standby server;
in a case where it is determined, according to the switching response information, that the standby server allows switching, sending a first switching instruction and the operation log information and configuration information of the standby server to the primary server to be restored; and
receiving configuration state information of the primary server to be restored, wherein the configuration state information is information that is generated by performing, by the primary server to be restored, application environment configuration according to the operation log information and the configuration information of the standby server in a case where the primary server to be restored receives the first switching instruction.

12. The method according to claim 11, further comprising:
storing, through a local memory of the accelerator card, operating state information, operation log information, and configuration information transmitted by the primary server and the standby server within a first time period; and
circularly storing, through a storage unit of the accelerator card, operating state information, operation log information, and configuration information transmitted by the primary server and the standby server within a second time period;
wherein a time interval between each time point within the first time period and a current time is less than or equal to a preset interval, and a time interval between each time point within the second time period and the current time is greater than the preset interval.

13. The method according to claim 12, further comprising:
in a case where it is determined, according to the switching response information, that the standby server allows switching, sending, by the accelerator card, a second switching instruction to the standby server;
acquiring memory information in the virtual application environment that is transmitted by the standby server through the PCIE interface in a mirrored manner; and
storing the memory information in the virtual application environment to the CXL memory;
wherein the memory information in the virtual application environment is information that is transmitted by the standby server in a case where the standby server receives the second switching instruction.

14. The method according to claim 13, further comprising:
in a case where it is determined, according to the configuration state information, that the primary server to be restored has completed the application environment configuration and it is determined, according to storage state information of the CXL memory, that the memory information in the virtual application environment that is transmitted by the standby server has been stored, sending, by the accelerator card, a third switching instruction to the primary server to be restored, and disconnecting a communication path between the PCIE interface and the standby server, restoring a connection between the CXL interface and a memory interface of the primary server to be restored.

15. The method according to claim 14, further comprising:
in a case where it is determined, according to the switching response information, that the standby server allows switching, disconnecting, by the accelerator card, a connection with a first data transmission interface of a switch, to control the first data transmission interface to enter a sleep mode.

16. The method according to claim 15, further comprising:
in a case where it is determined that the first data transmission interface enters the sleep mode, enabling, by the primary server to be restored, a connection with a second data transmission interface of the switch, to control the second data transmission interface to enter an active mode;
in a case where the third switching instruction is received and the second data transmission interface enters the active mode, receiving, through the second data transmission interface, data to be processed of the primary server to be restored;
reading the memory information of the virtual application environment from the CXL memory through the CXL interface;
updating an initial environment according to the memory information of the virtual application environment to obtain an updated application environment; and
restoring an application service of the primary server to be restored according to the updated application environment and the data to be processed of the primary server to be restored;
wherein the initial environment is an environment that is generated by performing application environment configuration according to the operation log information and the configuration information of the standby server.

17. A hot backup system, comprising: a plurality of accelerator cards, a plurality of primary servers, and one standby server, wherein
the accelerator cards are correspondingly connected to the primary servers on a one-to-one basis, and connected to the standby server;
each accelerator card comprises a Compute Express Link (CXL) interface and a CXL memory;
the accelerator card is configured to acquire operating state information, operation log information, and configuration information of a primary server from the primary server correspondingly connected to the accelerator card; store, in a mirrored manner, memory information of the primary server in a memory of the primary server to the CXL memory through a CXL interface, and determine whether the primary server has crashed according to the operating state information; in a case where the primary server has crashed, use the crashed primary server as a crashed primary server, acquire data to be processed that is to be transmitted to the crashed primary server, and transmit, to the standby server, the operation log information, the memory information, and the configuration information of the crashed primary server, and the data to be processed; and
the standby server is configured to generate a virtual application environment of the crashed primary server through simulation according to the operation log information, the memory information, and the configuration information of the crashed primary server, and execute an application service of the crashed primary server according to the virtual application environment and the data to be processed.

18. The system according to claim 17, further comprising a data base, wherein the data base is connected to each of the primary servers and the standby server.

19. An electronic device, comprising a memory, a processor, and computer-readable instructions that are stored on the memory and executable on the processor, wherein when the processor executes the computer-readable instructions, the method according to claim 1 is implemented.

20. A non-volatile computer readable storage medium, storing computer-readable instructions thereon, wherein when the computer-readable instructions are executed by a processor, the method according to claim 1 is implemented.
